(19) United States
(12) Patent Application Publication
(10) Pub. No.: US 2026/0005583 A1
(43) Pub. Date: Jan. 1, 2026

(54) SMART MODULES FOR A TOP-MOUNTED PLATE COOLER OF A DYNAMOELECTRIC MACHINE

(71) Applicant: SIEMENS AKTIENGESELLSCHAFT, München (DE)

(72) Inventor: Markus Hösle, Erlangen (DE)

(73) Assignee: Innomotics GmbH, 90441 Nümberg (DE)

(21) Appl. No.: 18/880,782

(22) PCT Filed: Jun. 14, 2023
(86) PCT No.: PCT/EP2023/065951

§ 371 Date: Jan. 2, 2025

(30) Foreign Application Priority Data
Jul. 29, 2022 (EP) 22187785.5

(51) Int. Cl. H02K 9/22; H02K 9/06; H02K 9/26

(52) U.S. Cl. CPC H02K 9/227; H02K 9/06; H02K 9/26

(57) ABSTRACT

A module for a top-mounted cooler, in particular plate heat exchanger of a dynamoelectric machine, has regions that are fluidically separate from one another and that permit the formation of a primary circuit and a secondary circuit. The module has at least one section that has an auxiliary fan and/or sensors and/or analysis possibilities and/or contact possibilities and/or communications with a superordinate controller. The module has closure mechanisms that correspond to a receiving opening in the top-mounted cooler. The module, when inserted into a receiving opening in the top-mounted cooler of the dynamoelectric machine, enables at least part of the primary circuit and at least part of the secondary circuit of the top-mounted cooler with the dynamoelectric machine.

The invention relates to intelligent modules of a top-mounted cooler of an enclosed dynamoelectric machine, to a top-mounted cooler of this kind, to a dynamoelectric machine of this kind, and to the use of such a dynamoelectric machine.

During operation, dynamoelectric machines produce losses, including iron and copper losses, which cause heat to build up in the machine. This heat must be dissipated from the machine in order to ensure proper operation of the dynamoelectric machine.

In principle, various cooling media are used, such as gas, especially air, or liquids, especially water.

In enclosed—in particular larger—dynamoelectric machines, there is an internal closed cooling circuit (primary circuit) in which air or another medium is circulated inside the dynamoelectric machine. The medium of said primary circuit is then re-cooled a heat exchanger (secondary circuit) disposed on the dynamoelectric machine, for example.

There are essentially two well-known air cooler principles (among others) for these enclosed dynamoelectric machines. One is the tube bundle air-to-air heat exchanger.

The disadvantage er e is the comparatively large construction volume required to provide a corresponding cooling performance, and also high manufacturing costs. The cleaning of the respective tubes of the tube bundle air-to-air heat exchanger, which is necessary to maintain the cooling performance, is also extremely time-consuming. In addition, symmetrical, in particular axially uniform cooling of the dynamoelectric machine is virtually impossible.

In order to avoid the aforementioned disadvantages, plate-type air-to-air heat exchangers, such as those known from WO 01/05017 A1 and WO 2016/046407 A1, are used for dynamoelectric machines.

Disadvantages here include the comparatively complex design and circuitous air routing.

Proceeding therefrom, the object of the invention is to provide an optimized cooling system for a dynamoelectric machine that, among other things, can be flexibly adapted to the requirements of the dynamoelectric machine and has a simple design.

This object is achieved by a module of a top-mounted cooler, in particular of a plate heat exchanger of a dynamoelectric machine, said module having areas that are fluidically separate from each other and allow a primary circuit and a secondary circuit to be formed, said module having at least one section containing an auxiliary fan and/or a sensor and/or analysis facilities and/or contacting options and/or means of communicating with a superordinate controller, said module having closure mechanisms corresponding to a receiving opening of the top-mounted cooler, said module, when inserted into a receiving opening of the top-mounted cooler of the dynamoelectric machine, enabling at least part of a primary circuit and at least part of a secondary circuit of the top-mounted cooler with the dynamoelectric machine.

The object of the invention is also achieved by an inventive top-mounted cooler of a dynamoelectric machine comprising a stator with a winding system and a rotor mounted so as to rotate about an axis, which top-mounted cooler can be configured with inventive modules to form a heat exchanger, in particular a plate heat exchanger,
wherein the op-mounted cooler has means for forming, with a dynamoelectric machine, a primary circuit and a secondary circuit that is fluidically separate therefrom,
wherein the top-mounted cooler has primary openings to the dynamoelectric machine which are used to form a primary circuit, and secondary openings which are used to form a secondary circuit,
wherein the top-mounted cooler has receiving openings for accommodating the modules,
wherein the top-mounted cooler constitutes a frame/housing which provides, in the receiving opening, an electrical contacting option for the modules and/or data interconnection of the modules and/or connections to a superordinate controller,
wherein, by inserting the modules into or removing them from their respective receiving openings, closure mechanisms are actuated to open/close the primary circuit and secondary circuit.

The object of the invention also achieved by a dynamoelectric having an inventive top-mounted cooler, wherein the enclosure of the dynamoelectric machine has openings that match corresponding primary openings of a top-mounted cooler such that, during operation of the dynamoelectric machine, a primary circuit is established which an be re-cooled by means of a cooling airflow of a secondary circuit via modules of the top-mounted cooler.

The object of the invention is also achieved by industrial machines, such as compressors, fans, pumps or blowers equipped with a dynamoelectric machine according to the invention, whereby the cooling performance can be adjusted, depending on use and installation site, via volume flow rates and the number and/or type of modules.

In addition to their plate-shaped design, the modules have a section that can be used for an auxiliary fan and/or sensors for detecting the temperatures of the respective cooling airflows, and/or analysis options for, among other things, residues in the cooling air (products of partial discharges in the insulation) and/or detecting noise emissions and eliminating them (e.g. initiating active vibration damping) and/or detecting unexpected air pressure differences, particularly in the area of the primary circuit, which may indicate unusual contamination or blockage of the circuits.

Among other things, this enables the cooling circuits of the primary circuit and secondary circuit of the entire top-mounted cooler and/or of the individual modules to be monitored using AI (artificial intelligence) and controlled via a central controller and/or a controller located directly on the module. For example, the cooling performance can be directly matched to the load of the dynamoelectric machine and/or the ambient temperature by adjusting the flow rate of the primary and/or secondary circuits.

In addition, the chemical resistance of the individual modules of the top-mounted cooler can be adapted to suit the operating location/intended use/environment of the plate heat exchanger or the dynamoelectric machine by using coated plates in each of the modules. This is particularly advantageous for using the modules and thus the dynamoelectric machine in an environment containing aggressive gases, especially at an explosion-proof installation site of the dynamoelectric machine.

The modular design of the plate heat exchanger implemented as a top-mounted cooler makes it easy to replace the individual modules for overhaul, cleaning, etc. The operation of the dynamoelectric machine does not have to be interrupted during maintenance of individual modules, as cooling can be maintained via the remaining modules or even compensated for by increasing their coolant throughput.

According to the invention, a top-mounted cooler is now provided which forms a primary circuit and a secondary circuit with a dynamoelectric machine, said top-mounted cooler merely comprising a framework/base structure with receiving openings for fans, air ducts, and receiving openings for the modules, wherein the modules are “intelligently” designed as required. As explained below, this includes sensors, the modules' own fans, specially designed and chemically resistant plates, integrated control electronics, airflow analysis capabilities, etc.

In other words, the framework/frame/housing of the top-mounted cooler serves only as a mechanical base structure that accommodates the cabling of the electrical power supply and/or data lines from and to the modules and/or a fan or pump of a secondary circuit.

Primary openings in the housing of the top-mounted cooler are to be understood as openings which, together with corresponding openings in the enclosure of the dynamoelectric machine, such as inflow and outflow channels, form a primary circuit.

Secondary openings in the housing of the top-mounted cooler are therefore openings that form a secondary circuit.

The openings of the top-mounted cooler are locked when the modules are removed, i.e. mechanical closure mechanisms prevent flow short circuiting between the primary circuit and the secondary circuit as well as within the circuits themselves. When the modules are pushed into the receiving openings, the circuits can re-form properly again.

These locking mechanisms have mechanically corresponding parts between the respective modules and their receiving openings. These include a mechanical lock to prevent unauthorized removal of a module. Opening and closing of the flow channels of the primary circuit and secondary circuit is additionally ensured. These mechanically corresponding parts also enable electrical contact between the respective module and the electrical supply provided in the top-mounted cooler.

The term primary circuit, irrespective of whether the dynamoelectric machine is ventilated from one or both sides, refers to the airflow or airflow distribution that surrounds or passes over the machine components such as the winding overhang area, winding overhang, laminated core, windings, enclosure, and bearings. This circuit is designed as a closed-loop system that has no flow-related contact with the outside. The airflow in the primary circuit is generated by one or more integrated fans and/or external fans of the dynamoelectric machine and/or by switchable auxiliary fans of the respective modules, operating in either blowing or suction mode.

The term secondary circuit refers to the airflow in the top-mounted cooler, which is thermally coupled with the airflow of the primary circuit, i.e. can re-cool it, whereby the airflow or airflow distribution of the secondary circuit is generated by integrated and/or external fans and/or by switchable auxiliary fans of the respective modules, operating in either blowing or suction mode.

The secondary circuit is preferably of open design, i.e. it is operated using ambient air that is drawn in from the environment and returned to the environment after being heated. This means that a dynamoelectric machine equipped with such a top-mounted cooler can be installed in almost any location. If necessary, filter mats or air filters for heavily contaminated air may have to be provided upstream of the secondary circuit.

Each airflow of both the primary circuit and the secondary circuit can be divided, at least in sections, into parallel flow paths along its course, particularly during heat exchange between the primary circuit and the secondary circuit. This is advantageously achieved using flow-guiding devices in the dynamoelectric machine and/or the top-mounted cooler to optimize the cooling efficiency of the airflow in the primary and/or secondary circuit.

Moreover, the secondary circuit can also be designed as a liquid cooling circuit—e.g. using water. In such cases, the modules operate as heat exchangers, transferring heat from the air of the primary circuit to the liquid of the secondary circuit. For efficient cooling, the controller then regulates the respective coolant flow in the primary and/or secondary circuit.

There is therefore a superordinate controller of the top-mounted cooler, which controller does not necessarily have to be disposed on the base framework of the top-mounted cooler (e.g. said controller can be located in a remote control room). According to the invention, depending on the design of the modules, a separate controller is also additionally provided on the module itself, which controller is subordinate to the higher-order controller of the top-mounted cooler. The module-level controllers thus not only support the cooling of the primary and/or secondary circuit, but also monitor the associated airflow streams for substances being conveyed through the modules, e.g. by the primary circuit, and provide insight into the condition of the machine, i.e. indicate that the machine requires maintenance. This can relate, among other factors, to the insulation of the winding system (partial discharges) or the condition of the bearings (abrasion of the rolling elements), etc.

These different possible embodiments of the modules mean that they can be adapted to suit to the intended use of the dynamoelectric machine and/or the required cooling performance of the top-mounted cooler. The modules have built-in intelligence and auxiliary fans, enabling optimized cooling (flow behavior, noise emissions) and the detection of pollutants in the cooling streams, as well as further actions derived therefrom, which have ultimately been stored as algorithms (AI, digital twin) in the controllers, and can initiate appropriate measures for the continued operation of the dynamoelectric machine.

The top-mounted cooler forms a basic structure which includes the wiring, the electrical contacting of the modules, and, if necessary, a controller superimposed on the respective cooling circuits which regulates the cooling of the dynamoelectric machine or, if applicable, other drives associated with the same process. This can be a rolling mill, a paper factory, or a conveyor system.

The acquisition and evaluation of measured values, the control of the cooling performance and/or the AI is thus shifted from the dynamoelectric machine to the modules of the top-mounted cooler and/or a superordinate controller.

According to the invention, a comparatively more efficient cooling system for dynamoelectric machines is now provided by a top-mounted cooler equipped with the inventive modules. By virtue of its modular design, it is also suitable for a primary circuit of single- and double-sided ventilation systems of dynamoelectric machines.

The modular design of the plate heat exchanger in the top-mounted cooler also facilitates simple replacement of the individual modules for overhaul, cleaning, etc. The operation of the dynamoelectric machine does not have to be interrupted when servicing individual modules, as cooling is maintained via the remaining modules which then automatically adapt to the respective cooling requirements by activating the auxiliary fan of the remaining modules or a higher-level external fan in the primary circuit and/or secondary circuit.

A reduction in cooling performance is only likely to occur if the remaining modules in the top-mounted cooler are no longer capable of providing the required cooling.

When a module is removed from the top-mounted cooler, its receiving opening is closed so as to prevent flow short circuiting in the primary circuit and/or secondary circuit that could impair the cooling performance. The integrity of the primary circuit and the secondary circuit is maintained via the remaining modules in the top-mounted cooler during operation of the dynamoelectric machine.

Advantageously, inexpensive standardized modules can also be inserted into these openings as plate heat exchangers. In that case, however, they do not form a controllable part of the cooling system.

The use of modules means that modules operating either according to the crossflow or counterflow principle can be inserted into the same housing of the top-mounted cooler. This allows adaptation to the intended use and/or required cooling performance of the top-mounted cooler.

The chemical resistance of the top-mounted cooler can be improved by using coated plates in each of the modules of the plate heat exchanger. The coating required in each case can be tailored to the chemical resistance requirements or the intended use of the top-mounted cooler disposed on the machine.

The invention and further advantageous embodiments of the invention will now be explained in more detail with reference to schematically illustrated examples, wherein:

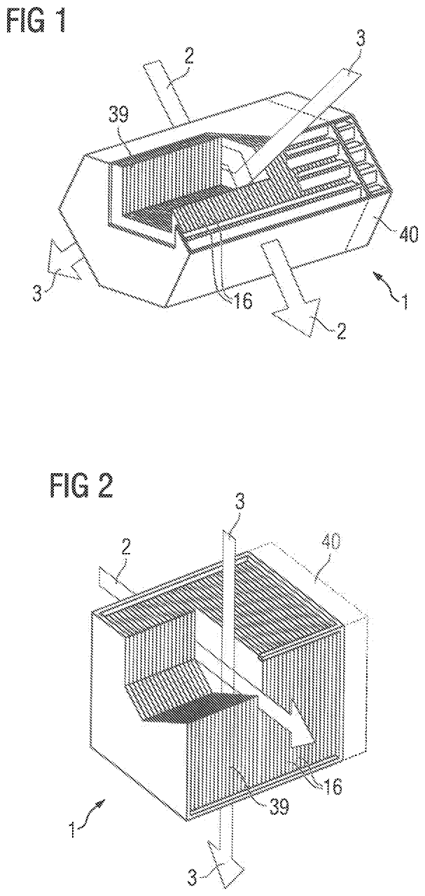

FIGS. 1, 2 show different designs of modules,

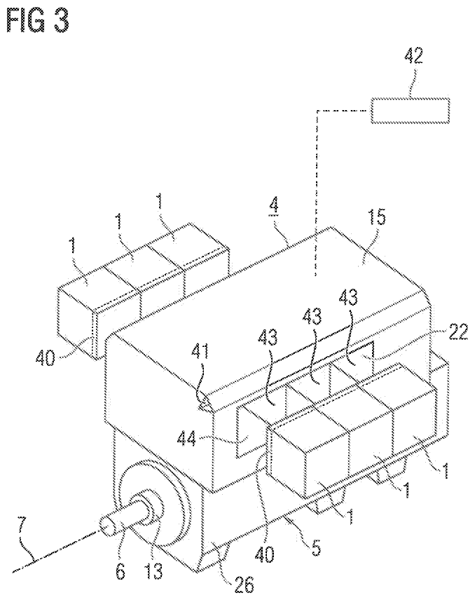

FIG. 3 shows a perspective view of a dynamoelectric machine with top-mounted cooler,

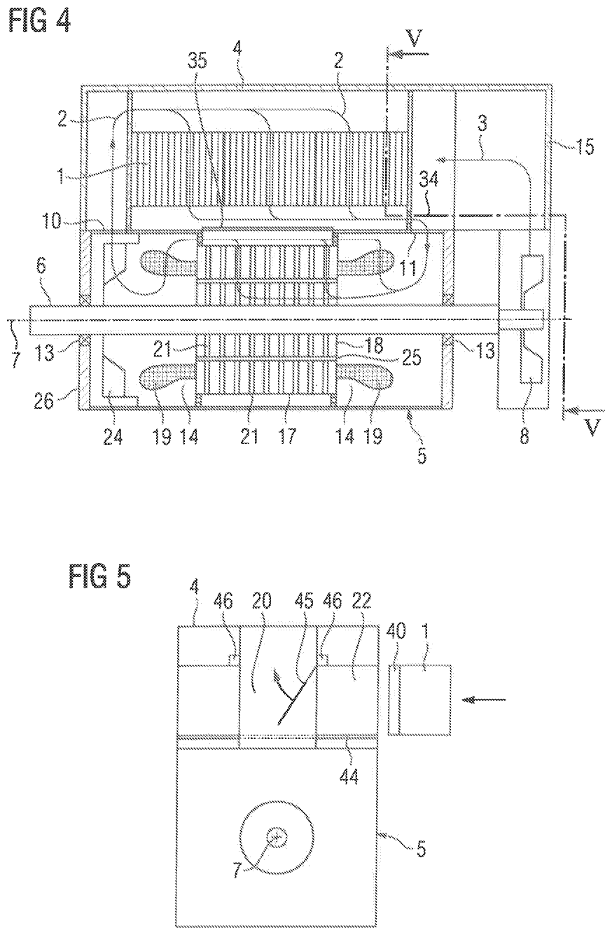

FIG. 4 shows longitudinal section through a dynamoelectric machine with top-mounted cooler,

FIG. 5 shows a cross-section through a dynamoelectric machine with top-mounted cooler,

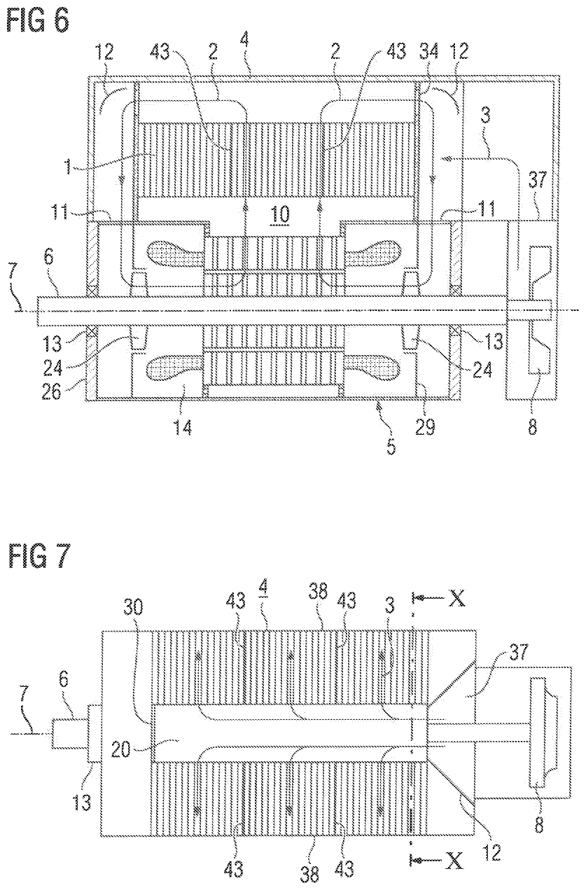

FIG. 6 shows a longitudinal section through a dynamoelectric machine with top-mounted cooler with a schematic primary circuit and secondary circuit,

FIG. 7 shows a plan view of a top-mounted cooler with a schematic secondary circuit,

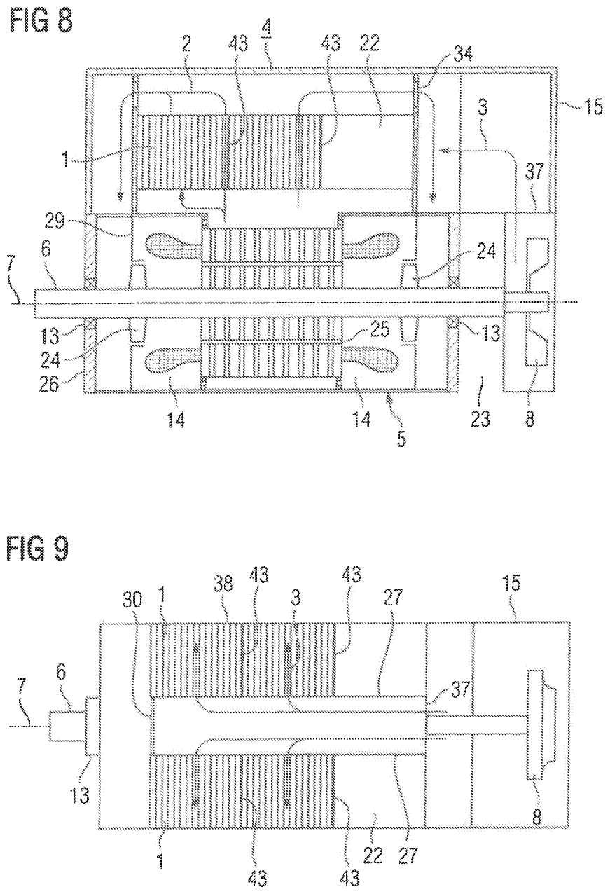

FIG. 8 shows a longitudinal section through a dynamoelectric machine with top-mounted cooler with a further schematic primary circuit and secondary circuit,

FIG. 9 shows a plan view of a top-mounted cooler with schematic secondary circuit with the modules removed,

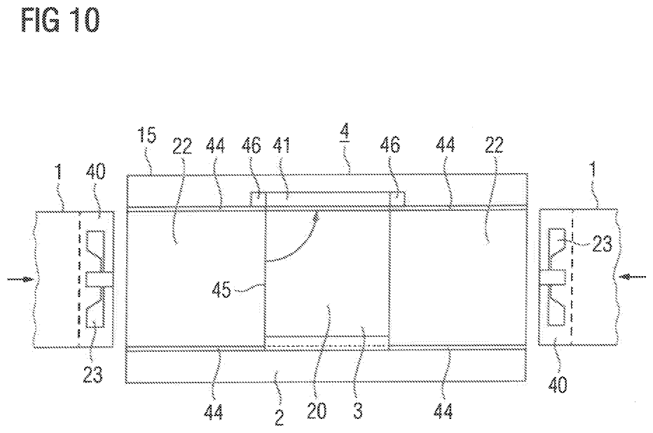

FIG. 10 shows a schematic representation of the partitioning.

It should be noted that terms such as “axial”, “radial”, “tangential” etc. refer to the axis 7 used in the respective figure or in the respective example described. In other words, the directions axial, radial, tangential always refer to an axis 7 of the rotor 18 and thus to the corresponding axis of symmetry of the stator 17. Here, “axial” describes a direction parallel to the axis 7, “radial” describes a direction orthogonal to the axis 7, toward or away from it, and “tangential” is a direction that is oriented circularly about the axis 7 at a constant radial distance from the axis 7 and at a constant axial position. The term “circumferential” is to be equated with “tangential”.

In relation to a surface, e.g. a cross-sectional surface, the terms “axial”, “radial”, “tangential” etc. describe the orientation of the normal vector of the surface, i.e. the vector that is perpendicular to the surface in question.

The term “coaxial components”, e.g. coaxial components such as rotor 18 and stator 17, is understood here to mean components that have the same normal vectors, i.e. for which the planes defined by the coaxial components are parallel to each other. In addition, the term is intended to imply that the centers of coaxial components lie on the same axis of rotation or symmetry. However, these center points may be located at different axial positions on this axis and the planes mentioned may therefore have a distance >0 from each other. The term does not necessarily require that coaxial components have the same radius.

The term “complementary” in the context of two components that are described as “complementary” to each other means that their external shapes are designed in such a way that one component can preferably be completely positioned on the component complementary to it, so that the inner surface of one component and the outer surface of the other ideally make complete contact, i.e. over their entire area. Consequently, in the case of two complementary objects, the external shape of one object is determined by the external shape of the other.

For the sake of clarity, in some cases where components are present more than once in the figures, not all of the components shown are provided with reference characters.

The designs described can be combined as desired. Individual features of the respective designs can also be combined without departing from the essence of the invention. For example, some figures show more the flow conditions within the modules 1 or the top-mounted cooler 4 or the dynamoelectric machine 5, while other figures show more the mechanics required for this in principle.

In order to avoid repetition, the description of embodiments already explained in principle and their reference characters will only focus on the supplementary or distinguishing features of the respective embodiment during the further course of the description.

FIG. 1 shows a module 1 of a plate heat exchanger having a hexagonal cross-section, the module 1 being six-sided. Plates 16 of the module 1 are disposed such that the airflows of a primary circuit 2 and a secondary circuit 3 can exchange heat within the module 1 via the plates.

FIG. 2 shows a module 1 of a plate heat exchanger having a rectangular cross-section, the module 1 being cube-shaped or cuboid. The plates 16 of the module 1 are disposed such that the airflows of the primary circuit 2 and secondary circuit 3 can exchange heat within the module 1 via the plates.

The common feature of both designs is that the modules 1 are composed of plates 16 in such a way that, in the successive gaps between adjacent plates 16, the airflow alternates between the primary circuit 2—i.e. the warmed air—and the secondary circuit 3—i.e. the heat-dissipating air.

The plate stack of each module 1 is sealed externally and between the airflows by sealing elements. Sealing can also be achieved by bonding or soldering the plate stack. The modules 1 are assembled using tension bolts or welded connections.

In order to intensify heat transfer between the primary circuit 2 and the secondary circuit 3 within a module 1, the plates 16 are preferably profiled so as to create turbulence in the respective flow.

In addition, the cooling performance of the individual modules 1 and a top-mounted cooler 4 equipped with them can be influenced by using a parallel-flow or counterflow principle for the primary circuit 2 and secondary circuit 3.

In FIG. 1 and FIG. 2, the sections of the airflows from the primary circuit 2 and secondary circuit 3 within the modules 1 are merely shown by way of example.

The airflows of the primary circuit 2 and secondary circuit 3 are optimized in their respective flow paths by corresponding and various flow-directing devices 12 in a top-mounted cooler 4.

The modules 1 include provisions for an auxiliary fan 23, sensors 39 to measure the temperature of the respective cooling airflows, and analysis facilities, including for residues in the cooling air (e.g. products of partial discharges in the insulation) and noise emissions, as well as their elimination. They can also detect unexpected air pressure differences which could indicate contamination, particularly in the primary circuit 2.

This allows the primary cooling flow and/or the secondary cooling flow of the entire top-mounted cooler 4 and/or of the individual modules 1, e.g. the volume flow rate of the cooling media and thus the overall cooling performance, to be controlled via AI (artificial intelligence) by means of a higher-level controller 42 (see FIG. 3) and adapted to the respective ambient conditions.

In addition, the chemical resistance of the individual modules 1 of the top-mounted cooler 4 can be adapted to the installation site/intended use/environment of the plate heat exchanger or the dynamoelectric machine 5 by using coated plates 16 in each of the modules 1.

Suitable materials for the plates 16 of the modules 1 are plastics, aluminum, steel, copper or stainless steel. It is also conceivable for the plates 16 of the modules 1 to be provided with an epoxy coating or other protective coatings.

These plates 16 can also be flat or corrugated.

The arrangement of the plates 16 in the modules 1, as schematically indicated, is intended solely as a general representation of the plate coolers in the modules 1 and does not necessarily specify a fixed flow direction for the primary circuit 2 and/or secondary circuit 3.

The section 40 of the modules 1 has in each case an auxiliary fan 23 and/or further sensors 39 for measuring the temperature of the respective cooling airflows and/or analysis capabilities for, among other things, residues in the cooling air (products of partial discharges in the insulation) and/or analysis capabilities for noise emissions and/or means for detecting unplanned air pressure differences, which can indicate contamination, particularly in the area of the primary circuit 2.

This means that the module 1 is intelligent and can control the cooling performance and/or the operating behavior of the dynamoelectric machine 6, in particular via the higher-level controller 42. If the cooling performance is insufficient, for example, the volumetric flow rate of the primary circuit 2 and/or secondary circuit 3 can be increased, or the dynamoelectric machine 5 can be operated in a less thermally demanding mode. If residues are detected in the primary circuit that indicate deteriorating insulation, the machine 5 can be shut down and a damage notification can be issued.

FIG. 3 shows a perspective view of the top-mounted cooler 4 on the enclosure 26 of the dynamoelectric machine 5. For illustrative purposes, the modules 1, which are designed as hexagonal or—as in this case—cube-shaped plate coolers, are shown removed from their, preferably complementary, receiving openings 22. Each of the modules 1 can be removed individually for cleaning the plates 16 or replacing them without creating a fluidic bypass through the unoccupied receiving opening 22 that would impair the cooling performance of the remaining modules 1. This is ensured by corresponding partition walls 43, flaps 45 and cover panels 44 of the receiving openings 22, which will be discussed later.

Insertion/receiving openings 22 are at least fluidically closed to the respective circuits (primary circuit 2, secondary circuit 3) when no module 1 is inserted, and the receiving openings 22 are opened to the primary circuit 2 and secondary circuit 3 when modules 1 are inserted and closed again when the modules 1 are removed. For example, covers or flaps are pushed aside or folded away against spring force when the modules 1 are inserted into the respective receiving openings 22. When the module 1 is removed from the receiving opening 22, these closure elements then shut, preventing the formation of a fluidic bypass.

FIG. 4 shows a longitudinal section through a dynamoelectric machine 5 with a top-mounted cooler 4. The dynamoelectric machine 5 is housed in an enclosure 26 which accommodates the bearings 13. The enclosure 26 of the dynamoelectric machine 5 is constructed as a sealed unit and has only predefined openings—inflow channels 10 and outflow channels 11—to the top-mounted cooler 4 which allow a primary circuit 2 to be formed within the enclosed dynamoelectric machine 5.

Openings (primary openings) are provided in the housing 15 of the top-mounted cooler 4 that correspond fluidically to the inflow channels 10 and outflow channels 11 in the enclosure 26 of the dynamoelectric machine 5, so that a closed primary circuit 2 is established. In addition, further flow-directing devices 12 are also disposed in the housing 15 in order to form a primary circuit 2 and secondary circuit 3.

FIG. 4 also shows a top-mounted cooler 4 of the dynamoelectric machine 5 with schematically illustrated single-sided ventilation of the primary circuit 2—also known as Z-ventilation. The re-cooled air of the primary circuit 2 enters the winding overhang space 14 on one side (here on the right), flows through the machine 1 in various ways, and exits the enclosure 26 via the winding overhang space on the other side (here on the left). In this design, the heated air of the primary circuit 2 is first directed upward within the top-mounted cooler 4, from where it is then re-cooled via the modules 1 on its “path” downward.

A stator 17 is fixedly positioned within the enclosure 26. In its laminated core slots (not shown in detail), the stator 17 contains a winding system which, when energized, generates electromagnetic interactions across an air gap 25 of the dynamoelectric machine 5, causing the rotor 18 to rotate about its axis 7. The rotor 18 can be of squirrel-cage design, creating an asynchronous dynamoelectric machine 5. The rotor 18 can also have permanent magnets, making the dynamoelectric machine 5 a synchronous machine (with non-salient or salient-pole rotors).

It is also possible to design the rotor 18 with its own winding system which is electrically supplied e.g. via a slip-ring arrangement.

In principle, the top-mounted cooler 4 is suitable for any conceivable type of dynamoelectric machine 5. The only requirement is that the inflow channels 10 and outflow channels 11 in the enclosure 26 of the dynamoelectric machine 5 align fluidically with the designated openings or recesses (primary openings) in the housing 16 of the top-mounted cooler 4.

The axially layered laminated cores of the stator 17 and rotor 18 are provided with radial channels 21 at predefinable intervals to improve the cooling of, among other things, the respective core and the winding system within the slots.

In addition, an internal fan 24 which conveys the air of the primary circuit 2 is provided. In this case, there is so-called single-sided ventilation, also known as Z-ventilation.

Single-sided ventilation refers to the ventilation of the dynamoelectric machine 5, where an airflow (primary circuit 2) is introduced on one side of the dynamoelectric machine 5 into a winding overhang space 14. It then travels through various parallel and/or serial flow channels—winding overhang 19, back of the stator's laminated core 17, radial cooling channels 21, air gap 25, etc.—before reaching the other winding overhang space 14. From there, the heated air of the primary circuit 2 passes via one or more fans—integrated fans or external fans—into the top-mounted cooler 4 for re-cooling.

The air from the primary circuit 2 is thus fed into the enclosure 26 of the dynamoelectric machine 5 via one winding overhang space 14 and then, via the winding overhang 19 and the laminated core and/or the air gap 25, into the other winding overhang space 14. From there, the now heated cooling airflow is re-cooled via the top-mounted cooler 4, in particular the modules 1 disposed therein, by means of the secondary circuit 3.

In this and the other embodiment examples, the primary circuits 2 and or secondary circuits 3 are only partially shown. In FIG. 3, for example, only a part of the primary circuit 2 above the axis 7 is shown. The primary circuit 2 or part of it also runs in the lower section, as well as in other areas of the interior of the dynamoelectric machine 5, such as e.g. in the air gap 25.

The housing 15 of the top-mounted cooler 4 includes noise-damping elements to reduce sound emissions in the vicinity of the dynamoelectric machine 5.

A fan 8 generates a cooling airflow of the secondary circuit 3, which re-cools the heated cooling airflow of the primary circuit 2 via the plate heat exchangers in the modules 1.

In this case, the fan 8 is an integrated fan that is fixedly connected to the shaft 6. Alternatively or additionally, however, external fans 31 on and/or attached to the top-mounted cooler 4 can also be used to support the cooling airflow of the secondary circuit 3.

As FIG. 5 also shows, the modules 1 are preferably disposed along a central channel 20 which extends parallel to the axis at least in sections. In this embodiment, the modules 1 are disposed on both sides of the central channel 20.

FIG. 6 shows a top-mounted cooler 4 of a dynamoelectric machine 5 with schematically illustrated double-sided ventilation of the primary circuit 2—also referred to as X-ventilation. Compared to the design shown in FIG. 4, the cover plate 35, which is required, among other things, for one-sided ventilation and for adjusting flow-directing devices 12 in the top-mounted cooler 4, has been removed.

Double-sided ventilation refers to the ventilation of dynamoelectric machines 5, whereby an airflow (primary circuit 2) is introduced into the winding overhang space 14 on both sides of the dynamoelectric machine 5 and then passes through various parallel and/or serial flow channels—winding overhang 19, back of the laminated core the stator 17, radial cooling channels 21, air gap 25, etc.—to reach the top-mounted cooler 4 essentially at the midpoint along the back of the stator core. The heated air from the primary circuit 2 is conveyed into the top-mounted cooler 4 for re-cooling by one or more fans, either integrated or external. Corresponding baffle elements 29 improve the flow behavior of the primary circuit 2.

FIG. 7 shows a plan view of the top-mounted cooler 4 with a schematic representation of airflow in the secondary circuit 3. An integrated fan 8 and/or an external fan 31 pushes airflow axially through an intake air channel 37 into the central channel 20 which re-cools air from the primary circuit 2 via plate heat exchangers in the modules 1. The heated air exits the housing 15 of the top-mounted cooler 4 via the exhaust air channels 38.

FIG. 8 shows another possible application of the top-mounted cooler 4 according to the invention for double-sided ventilation of the dynamoelectric machine 6. In this example, one receiving opening 22 is not in use. As a result, the flow-directing devices 12, flaps 45 and cover panels 44 of the top-mounted cooler 4 are positioned so as to prevent flow short circuits. The primary circuit 2 and/or secondary circuit 3 in said receiving opening 22 remains closed when the opening is “unoccupied”.

FIG. 9 shows the corresponding design of the secondary circuit 3 whose unused receiving openings 22 for the secondary circuit 3 are locked to prevent flow short circuits.

FIG. 10 schematically illustrates how the modules 1 are inserted into the receiving opening 22, whereby, on insertion, a flap 46 is folded upward to open the secondary circuit. At the same time, the module 1 at the top and bottom of the receiving opening 22 displaces the cover panels 44 toward the central channel 20, thus opening the primary circuit. Once the modules 1 are pushed in, electrical contact is also made, e.g. to supply the auxiliary fan 23 and/or the controller and analysis unit.

These mechanical closure mechanisms can also be of different design, but the essential requirement is always that the secondary and primary circuits are only “enabled” when the modules 1 are inserted.

It is also possible for one side of an asymmetrically configured central channel 20 of the top-mounted cooler 4 to advantageously house the intelligent modules 1, while the other side accommodates standardized modules having a smaller installation depth.

It is further conceivable for an auxiliary fan 31, particularly an axial fan, to be fluidically connected to the secondary circuit 3 via a hood (not shown in detail). For example, it can be positioned on the top-mounted cooler 4.

To supplement an integrated fan 8 and or an external fan, an additional external fan 31 that additionally drives the airflow of the secondary circuit 3 can be positioned in the central channel 20 to help maintain or accelerate the airflow in the secondary circuit 3.

The individual modules 1 are preferably traversed in parallel by the secondary airflow 3. Each module 1 provides virtually identical cooling performance, as the secondary airflow 3 has a nearly uniform temperature before entering each module 1. Cooling performance can be enhanced by an external fan—see above—or by the module's own auxiliary fan 23.

It is also possible for the cooler 4 to be installed in a different room from the dynamoelectric machine 5. In this case, the primary cooling airflow 2 must be routed via corresponding supply lines.

There are several options for routing the heated exhaust air of the secondary circuit 3 that exits from the exhaust air channel 38, i.e. from the modules 1. Guide elements can direct this exhaust air obliquely downward or initially in an axis-parallel direction and then optionally obliquely upward. Axis-parallel alignments of the guide elements are also conceivable, directing the heated exhaust air of the secondary circuit 3 in one and/or the other direction.

By appropriately aligning the guide elements, the heated exhaust air of the secondary circuit 3 can also be directed upward and/or downward.

To provide soundproofing for the top-mounted cooler 4, the interior of the housing 15 and/or the air outlet surface of the secondary circuit 3 can be oriented and/or provided with sound-damping elements, at least in sections, without impairing the cooling performance of the top-mounted cooler 4.

The inventive design of the top-mounted cooler 4 allows for all known structural formats, enabling the dynamoelectric machine 5 to be installed vertically, horizontally, or inclined at a predefinable angle (IM1001 . . . ).

The inventive design of the top-mounted cooler 4 also supports all known cooling types, such as IC611, IC616, IC666, IC661, etc.

The top-mounted cooler 4 does not necessarily have to be mounted on top of the machine 5. It can also be disposed on the side of the machine or even underneath the machine or in a separate adjacent room.

Irrespective of the type of cooling (Z- or X-ventilation), the shaft-mounted fans 24 of the primary circuit 2 that are provided inside the enclosure 26 can be positioned, within the enclosure 26 of the dynamoelectric machine 5, on the side facing a driven machine and/or on the side facing away from a driven machine (i.e. on the DE side (Drive-End) or NDE side (Non-Drive-End)).

This also applies in principle to the fan 8 which—if provided—can also be disposed on the DE side and/or NDE side of the dynamoelectric machine 5.

In order to maintain the secondary circuit 3 and/or the primary circuit 2, at least one external fan 31 can also be additionally or exclusively provided which pushes or draws the required airflow through the secondary circuit 3.

As explained above, these external fans 31 can be located at almost any locations in the primary circuit 2 and/or secondary circuit 3.

This inventive top-mounted cooler 4 is also suitable for explosion-proof systems. In such cases, the dynamoelectric machine 5 is designed as a closed system. Particular attention must then be paid, where appropriate, to sealing any gaps, particularly between the modules 1, to prevent potentially explosive gases from entering the primary circuit 2 and, consequently, the winding system of the dynamoelectric machine 5. This can also be monitored by sensors 39 installed in the modules 1.

Besides air, other gaseous media, such as, e.g. nitrogen, can also be used as cooling media for the primary circuit 2 and/or secondary circuit 3. Liquid cooling media, such as oil or water, are also conceivable for the primary circuit 2 and/or secondary circuit 3. The decisive factor is always the heat exchange between primary circuit 2 and secondary circuit 3 via the intelligent modules 1 of the top-mounted cooler 4, which are designed as plate coolers, and their ability to analyze the cooling process or rather the state of the dynamoelectric machine 5.

1.-13. (canceled)

14. A dynamoelectric machine, comprising:
a stator comprising a winding system;
a rotor mounted for rotation about an axis and interacting with the stator;
a top-mounted cooler including receiving openings for accommodating modules to form a heat exchanger, in particular a plate heat exchanger, the top-mounted cooler designed in conjunction with the dynamoelectric machine to implement a primary circuit and a secondary circuit which is fluidically separate from the primary circuit, with the top-mounted cooler including primary openings to the dynamoelectric machine to implement the primary circuit, and secondary openings to implement the secondary circuit, said top-mounted cooler forming a frame or housing which provides, for the modules, an electrical contacting facility and/or data interconnection of the modules and/or connections to a superordinate controller in a corresponding one of the receiving openings, wherein by inserting the modules into, or removing them from, their respective receiving openings, closure mechanisms for opening or closing the primary circuit and the secondary circuit are actuated, wherein one of the modules of the top-mounted cooler has areas fluidically separated from one another which enable the primary circuit and the secondary circuit to be implemented, said one module having at least one section containing an auxiliary fan and/or a sensor and/or analysis facilities and/or contacting options and/or designed to communicate with the superordinate controller, wherein the one module, when inserted into a corresponding one of the receiving openings of the top-mounted cooler enables at least part of the primary circuit and at least part of the secondary circuit; and
an enclosure having openings in correspondence with the primary openings such that during operation of the dynamoelectric machine, the primary circuit is established which is re-coolable by a cooling airflow of the secondary circuit via the modules of the top-mounted cooler.

15. The dynamo-electric machine of claim 14, wherein the sensor is disposed in the primary circuit and/or in the secondary circuit and/or in the section of the one module.

16. The dynamo-electric machine of claim 14, wherein the closure mechanisms are designed as displaceable cover panels and/or flaps.

17. The dynamo-electric machine of claim 14, wherein the fluidically separate areas of the one module as part of the primary circuit and part of the secondary circuit are designed as plates.

18. The dynamo-electric machine of claim 17, wherein the plates are implemented as surface-enlarging structures, in particular of corrugated design.

19. The dynamo-electric machine of claim 14, wherein the top-mounted cooler includes a central channel disposed in parallel relation to the axis and designed to receive an airflow of the secondary circuit for the modules, the dynamo-electric machine further comprising integrated and/or external fans which are designed to generate the airflow and disposed directly on the dynamo-electric machine or in a vicinity of the dynamoelectric machine.

20. The dynamo-electric machine of claim 14, wherein the secondary circuit has an open design to allow operation using ambient air.

21. The dynamo-electric machine of claim 14, wherein the housing of the top-mounted cooler has openings for at least one inflow channel and at least one outflow channel of the primary circuit, and openings for intake air and exhaust air channels of the secondary circuit.

22. The dynamo-electric machine of claim 14, wherein the housing of the top-mounted cooler comprises flow-directing devices and/or the closure mechanisms of the primary circuit and/or the secondary circuit.

23. The dynamo-electric machine of claim 19, further comprising an air filter disposed upstream of an inlet for ambient air into the secondary circuit, in particular upstream of the central channel.

24. The dynamo-electric machine of claim 14, further comprising an external fan and/or an integrated fan designed to generate the cooling airflow of the primary circuit and/or secondary circuit, and/or wherein the cooling airflow is assisted, in particular optionally, by auxiliary fans of the modules.

25. The dynamo-electric machine of claim 24, wherein the sensor is designed to detect data including a cooling temperature in the primary circuit and/or in the secondary circuit and/or vibrations and/or a rotational speed of the dynamoelectric machine, the dynamo-electric machine further comprising a control device receiving the data to control a speed of the external fan and/or flow-directing devices of the primary and secondary circuits.

26. An industrial driven machine such as compressor, fan, pump or blower, the industrial driven machine comprising the dynamoelectric machine of claim 14, wherein a cooling performance of the dynamoelectric machine is adjustable according to use and installation site of the dynamoelectric machine via adjustable volume flow rates of the primary circuit and/or the secondary circuit and/or via a number of the modules and/or type of the modules.
